(19) United States
(12) Patent Application Publication
(10) Pub. No.: US 2002/0013822 A1
(43) Pub. Date: Jan. 31, 2002

(54) Shared as needed programming model

(76) Inventor: Karlon K. West, Austin, TX (US)

Correspondence Address: John J. Bruckner, FULBRIGHT & JAWORSKI L.L.P., Suite 2400, 600 Congress Avenue, Austin, TX, 78701, US

(21) Appl. No.: 09/915,002

(22) Filed: Jul. 25, 2001

Related U.S. Application Data
(60) Provisional application No. 60/220,974, filed on Jul. 26, 2000.
(60) Provisional application No. 60/220,748, filed on Jul. 26, 2000.

(51) Int. Cl. G06F 15/16; G06F 15/167

(52) U.S. Cl. 709/213; 709/219

(57) ABSTRACT

Systems and methods are described for a shared as needed programming model. A method includes: interconnecting a compute node with a shared memory node via hardware over a link medium; and providing a shared memory operating system extension layer. An apparatus, includes: a compute node; a link medium coupled to the compute node; and a shared memory node coupled to the link medium, the shared memory mode including a shared memory operating system extension layer.

### CROSS-REFERENCES TO RELATED APPLICATIONS

This application is a continuation-in-part of, and claims a benefit of priority under 35 U.S.C. 119(e) and/or 35 U.S.C. 120 from, copending U.S. Ser. No. 60/220,974, filed Jul. 26, 2000, and No. 60/220,748, filed Jul. 26, 2000, the entire contents of both of which are hereby expressly incorporated by reference for all purposes.

### BACKGROUND OF THE INVENTION

1. Field of the Invention

The invention relates generally to the field of computer systems. More particularly, the invention relates to computer systems where one or more central processing units (CPUs) are connected to one or more memory (RAM) subsystems, or portions thereof, where each CPU can access a portion of the RAM subsystem with a lower latency and/or higher bandwidth than other portions of the RAM subsystem that are shared among a plurality of CPUs.

2. Discussion of the Related Art

In a typical computing system, every CPU can access all of RAM, either directly with Load and Store instructions, or indirectly, such as with a message passing scheme.

When more than one CPU can access or manage the RAM subsystem or a portion thereof, accesses to those shared portions of RAM are generally much slower (with more system overhead) than in the portions of the RAM that are local to each CPU. High access rates to those shared portions of RAM in turn generates contention for the shared RAM subsystem buses by multiple CPUs and thereby reduces overall system performance.

Problems with this technology include contention for the shared RAM subsystem buses by multiple CPUs, and reduced overall system performance. Therefore, what is required is a means to develop applications and programs that primarily use the faster RAM, and only use shared RAM for information exchange between CPUs that do not have access to the same portion of fast access RAM, and at similar speeds of access.

Heretofore, the requirement of a method to develop applications and programs that primarily use the faster RAM, and only use the shared RAM for information exchange between CPUs that do not have access to the same portion of fast access RAM at a similar speeds of access referred to above has not been fully met. What is needed is a solution that addresses this requirement.

### SUMMARY OF THE INVENTION

There is a need for the following embodiments. Of course, the invention is not limited to these embodiments.

According to a first aspect of the invention, a method comprises: interconnecting a compute node with a shared memory node via hardware over a link medium; and providing a shared memory operating system extension layer. According to a second aspect of the invention, an apparatus, comprises: a compute node; a link medium coupled to the compute node; and a shared memory node coupled to the link medium, the shared memory mode including a shared memory operating system extension layer.

These, and other, embodiments of the invention will be better appreciated and understood when considered in conjunction with the following description and the accompanying drawings. It should be understood, however, that the following description, while indicating various embodiments of the invention and numerous specific details thereof, is given by way of illustration and not of limitation. Many substitutions, modifications, additions and/or rearrangements may be made within the scope of the invention without departing from the spirit thereof, and the invention includes all such substitutions, modifications, additions and/or rearrangements.

### BRIEF DESCRIPTION OF THE DRAWINGS

The drawings accompanying and forming part of this specification are included to depict certain aspects of the invention. A clearer conception of the invention, and of the components and operation of systems provided with the invention, will become more readily apparent by referring to the exemplary, and therefore nonlimiting, embodiments illustrated in the drawings, wherein like reference numerals (if they occur in more than one view) designate the same elements. The invention may be better understood by reference to one or more of these drawings in combination with the description presented herein. It should be noted that the features illustrated in the drawings are not necessarily drawn to scale.

FIG. 1 illustrates a flowchart diagram of a shared memory function that can be implemented by a computer program, representing an embodiment of the invention.

FIG. 2 illustrates a flowchart diagram of a shared memory function that can be implemented by a computer program, representing an embodiment of the invention.

FIG. 3 illustrates a flowchart diagram of a lock function that can be implemented by a computer program, representing an embodiment of the invention.

FIG. 4 illustrates a flowchart diagram of a lock function that can be implemented by a computer program, representing an embodiment of the invention.

FIG. 5 illustrates a flowchart diagram of a lock function that can be implemented by a computer program, representing an embodiment of the invention.

FIG. 6 illustrates a flowchart diagram of a lock function that can be implemented by a computer program, representing an embodiment of the invention.

FIG. 7 illustrates a flowchart diagram of a processor function that can be implemented by a computer program, representing an embodiment of the invention.

FIG. 8 illustrates a flowchart diagram of a processor function that can be implemented by a computer program, representing an embodiment of the invention.

FIG. 9 illustrates a flowchart diagram of a processor function that can be implemented by a computer program, representing an embodiment of the invention.

FIG. 10 illustrates a flowchart diagram of a processor function that can be implemented by a computer program, representing an embodiment of the invention.

### DESCRIPTION OF PREFERRED EMBODIMENTS

The invention and the various features and advantageous details thereof are explained more fully with reference to the nonlimiting embodiments that are illustrated in the accompanying drawings and detailed in the following description. Descriptions of well known components and processing techniques are omitted so as not to unnecessarily obscure the invention in detail. It should be understood, however, that the detailed description and the specific examples, while indicating preferred embodiments of the invention, are given by way of illustration only and not by way of limitation. Various substitutions, modifications, additions and/or rearrangements within the spirit and/or scope of the underlying inventive concept will become apparent to those skilled in the art from this detailed description.

The below-referenced U.S. Patent Applications disclose embodiments that were satisfactory for the purposes for which they are intended. The entire contents of U.S. Ser. No. 09/273,430, filed Mar. 19, 1999; Ser. No. 09/859,193, filed May 15, 2001; Ser. No. 09/854,351, filed May 10, 2001; Ser. No. 09/672,909, filed Sep. 28, 2000; Ser. No. 09/653,189, filed Aug. 31, 2000; Ser. No. 09/652,815, filed Aug. 31, 2000; Ser. No. 09/653,183, filed Aug. 31, 2000; Ser. No. 09/653,425, filed Aug. 31, 2000; Ser. No. 09/653,421, filed Aug. 31, 2000; Ser. No. 09/653,557, filed Aug. 31, 2000; Ser. No. 09/653,475, filed Aug. 31, 2000; Ser. No. 09/653,429, filed Aug. 31, 2000; Ser. No. 09/653,502, filed Aug. 31, 2000; Ser. No. ______ (Attorney Docket No. TNSY:017US), filed Jul. 25, 2001; Ser. No. ______ (Attorney Docket No. TNSY:018US), filed Jul. 25, 2001; Ser. No. ______ (Attorney Docket No. TNSY:019US), filed Jul. 25, 2001; Ser. No. ______ (Attorney Docket No. TNSY:020US), filed Jul. 25, 2001; Ser. No. ______ (Attorney Docket No. TNSY:021US), filed Jul. 25, 2001; Ser. No. ______ (Attorney Docket No. TNSY:022US), filed Jul. 25, 2001 Ser. No. ______ (Attorney Docket No. TNSY:023US), filed Jul. 25, 2001; Ser. No. ______ (Attorney Docket No. TNSY:024US), filed Jul. 25, 2001; and Ser. No. ______ (Attorney Docket No. TNSY:026US), filed Jul. 25, 2001 are hereby expressly incorporated by reference herein for all purposes.

In a computer system where more than one CPU has access to the RAM subsystem, or portions thereof, some means of providing mutually exclusive access to the shared memory among the multiple CPUs must be provided. Traditionally, this is done with spinlocks, Test-and-Set registers, or bus locking mechanisms. In any of these scenarios, while a CPU is accessing shared memory, if another CPU also needs to manipulate the same portions of shared memory, the other CPU(s) must wait until the first CPU is finished to maintain coherence and data integrity. In the general case, access to the shared portions of memory are also sometimes much slower than access to the CPU's local RAM, so that the locking mechanisms are held longer, shared memory contention increases, and thus the performance of the overall system is adversely affected.

In a computing system where each CPU has fast access to a portion of the RAM subsystem, such that the other CPUs can not, or at least do not, access that portion of the RAM subsystem, a methodology can be designed where the possibility of more than one CPU needing to access the memory management data structures simultaneously is lowered, thereby reducing contention and increasing overall system performance.

Scardamalia et al U.S. Ser. No. 09/273,430, filed Mar. 19, 1999 have described a system in which each computer node has its own, private memory, but in which there is also provided a shared global memory, accessible by all compute nodes. As part of this system, there also exists a global Atomic Complex, which contains Test-And-Set registers, as well as signaling registers. In this case, contention for shared memory only occurs when more than one node is attempting to access some shared memory at the same time. It is also possible in a NUMA-based compute system, where all memory is shared among all CPU, but that each CPU has a portion of RAM that it can access faster than other portion of the RAM subsystem. If each CPU reserves a portion of that local, fast access RAM and that no other processor accesses that portion, then the techniques described by this invention also apply to that computer system.

In a system as described above, the basic methods needed to access and manage the global shared memory fall into several categories, including but not limited to the following:

Shared Memory Management:

Reserve & Release Shared Memory

Read & Write Shared Memory

Interprocessor Synchronization

Locks

Semaphores

Interprocessor Communication

Events

Messages

Signals

To address the Shared Memory management requirements, the following function calls are provided, with typed parameters to allow extensions to the definitions of the function calls without changing the function call interface:

shared_memory_allocate( )

shared_memory_release( )

Each of the above function calls manage one or more pools of shared memory, allowing applications to reserve varying lengths of contiguous shared memory to hold data that can be shared and/or updated by one of more processors in the computing system. It is obvious to one skilled in the art, that various other function calls dealing with shared memory management may also be employed, including but not limited to marking certain shared memory regions as exclusive to a single processor, or private to a set of one or more processors, transferring ownership of shared memory regions from one processor to another, etc.

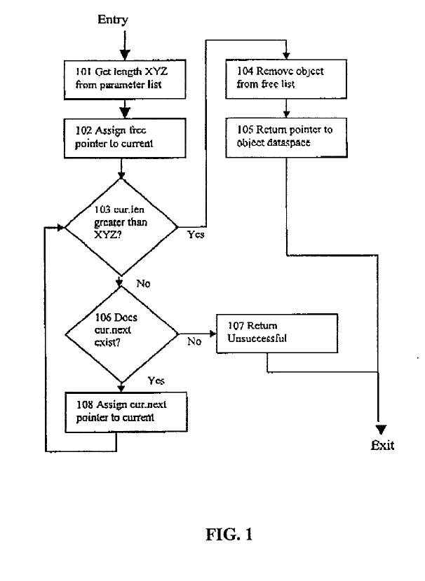

Referring to FIG. 1, a decision flow diagram of an implementation of a shared_memory_allocate( ) function is depicted. The primary parameter to this function is the length of memory requested. Element 101 gets the length from the parameter list, which is linked list of data structures that contain pointers to the next item in the list and the size of the current structure. Element 103 starts a decision loop, scanning the free list of objects to see if they can satisfy the memory allocation request. If the current object is large enough to satisfy the request, control flows to element 104 which removes the current object from the free list, and then element 105 returns the pointer to the object dataspace. If the current object is not large enough to satisfy the request, then the existence of the next object is checked in element 106. If there are no more objects in the free list, the control falls to element 107, which returns and allocation failure to the caller. If there is a next object in the list, element 108 sets the current pointer to that object and goes back to element 103.

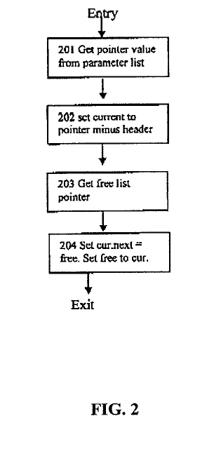

Referring to FIG. 2, a decision flow diagram of an implementation of a shared_memory_release( ) function is depicted. The primary parameter to this function is the pointer value. The start of the object can be obtained by using this value. Element 201 gets the pointer value from the parameters. Element 202 gets the object pointer by subtracting the number of bytes in the object header from the pointer passed in. Element 203 gets the pointer of the free memory list. Finally, element 204 sets the current object's next pointer to be the head of the free list, and sets the free list pointer to point to the current object.

To address the Interprocessor Synchronization requirements, the following function calls are provided, with typed parameters to allow extensions to the definitions of the function calls without changing the function call interface.

reserve_global_lock_identifier( )

release_global_lock_identifier( )

acquire_global_lock( )

release_global_lock( )

The first two functions above allow the application to set aside one or more global synchronization primitives for use by the applications, in order for the application to maintain data integrity in what the application stores in shared memory. The next two functions actually perform the locking and releasing of the global locks. It is obvious to one skilled in the art that these functions can be implemented in several ways, including but not limited to spinlocking, asynchronous locking, directed unlocking, etc.

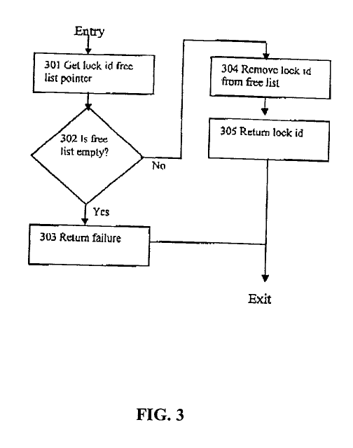

Referring to FIG. 3, a decision flow diagram of an implementation of a reserve_global_lock_indentifier( ) function is depicted. Element 301 gets the free pointer to the list of lock identifiers. Element 302 checks to see if the list is empty. If the list is empty, element 303 returns a failure. If the list is not empty, element 304 removes the first lock identifier from the free list, and element 305 returns the lock identifier.

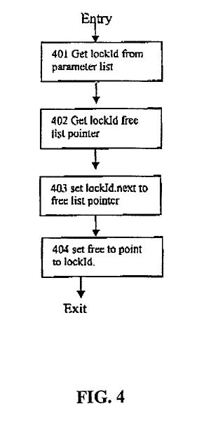

Referring to FIG. 4, a decision flow diagram of an implementation of a release_global_lock_indentifier( ) function is depicted. This function can be used to return a lock identifier to the free list. Element 401 gets the lock identifier from the parameter list. Element 402 gets the free list pointer for the global lock identifier list. Element 403 sets the current lock identifier's next pointer to the free list. And element 404 sets the free list to point to the current lock identifier.

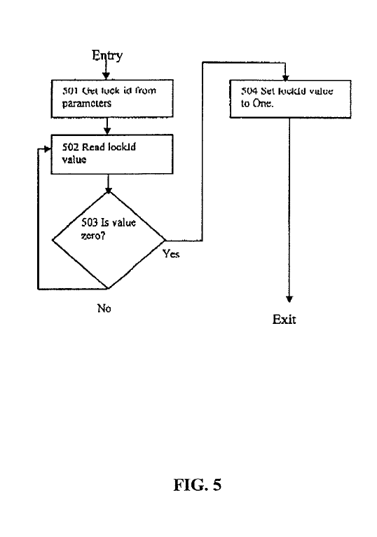

Referring to FIG. 5, a decision flow diagram of an implementation of a acquire_global_lock( ) function is depicted. This function can be implemented as a spinlock. Element 502 reads the value of the lock identifier. Element 503 implements the spinning loop, by checking if the value is zero. Element 504 changes the value to one, and then returns to the caller.

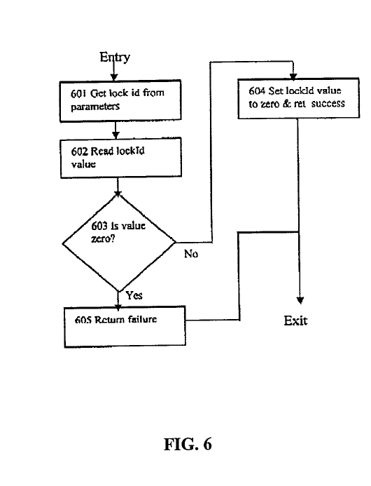

Referring to FIG. 6, a decision flow diagram of an implementation of a release_global_lock( ) function is depicted. This function can be implemented as a spinlock. Element 601 gets the lock identifier from the parameter list. Element 602 reads the value of the lock identifier. Element 603 decides what do based on the value of the lock identifier. If the value of the lock identifier is one, element 604 sets the value to zero and returns success. If the value of the lock identifier is zero, element 605 returns a failure.

Finally, to address the Interprocessor Communication requirements, the following function calls are provided, with typed parameters to allow extensions to the definitions of the function calls without changing the function call interface:

signal_a_single_processor( )

signal_all_processors( )

send_a_message_to_single_processor( )

send_a_message_to_all_processors( )

The first two functions above allow an application running on a given processor to send a signal to one or more processors, assuming applications on the other processors are waiting for a signal. The next two functions give an application the ability to easily exchange data with other applications running on other processors without directly managing the shared memory reservations and signaling, but by encompassing those two functions into a single functional interface.

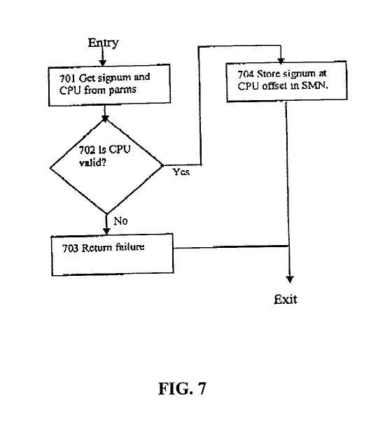

Referring to FIG. 7, a decision flow diagram of an implementation of a signal_a_single_processor( ) function is depicted. Element 701 gets the signal number and destination CPU number from the parameter list. Element 702 verifies whether the destination CPU if valid. If the destination CPU is not valid, element 703 returns a failure to the calling process. If the destination CPU is valid, element 704 puts the signal number in the atomic complex at the index of the destination CPU.

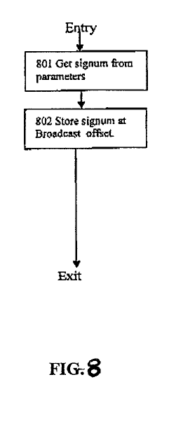

Referring to FIG. 8, a decision flow diagram of an implementation of a signal_all_processors( ) function is depicted. Element 801 gets the signal number from the parameter list. Element 802 stores the signal number in the atomic complex at the index of the signal-broadcast register.

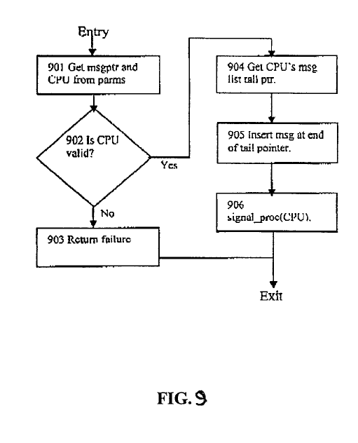

Referring to FIG. 9, a decision flow diagram of an implementation of a send_message_to_single_processor( ) function is depicted. Element 901 gets the destination CPU and a pointer to the message to be sent from the parameter list. Element 902 determines if the destination CPU is valid. If the destination CPU is not valid, element 903 returns a failure. If the destination CPU is valid, element 904 gets the message tail list pointer for the destination CPU. Element 905 inserts the message at the end of the message list. Element 906 calls the signal_a_single_processor( ) function for the destination CPU.

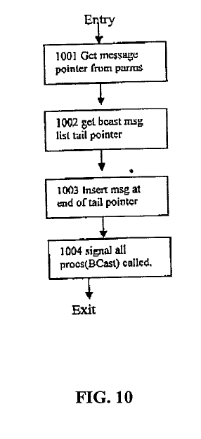

Referring to FIG. 10, a decision flow diagram of an implementation of a send_message_all_processors( ) function is depicted. Element 1001 gets the destination CPU and a pointer to the message to be sent from the parameter list. Element 1002 gets the message tail list pointer for the broadcast message list. Element 1003 inserts the message at the end of the message list. Element 1004 calls signal_all_processors( ) function with the broadcast message signal number.

The context of the invention can include computer systems. The context of the invention can also include computer systems where one or more central processing units (CPUs) are connected to one or more memory (RAM) subsystems, or portions thereof, and where each CPU can access a portion of the RAM subsystem with a lower latency and/or higher bandwidth than other portions of the RAM subsystem that are shared among a plurality of CPUs.

The invention can also be included in a kit. The kit can include some, or all, of the components that compose the invention. The kit can be an in-the-field retrofit kit to improve existing systems that are capable of incorporating the invention. The kit can include software, firmware and/or hardware for carrying out the invention. The kit can also contain instructions for practicing the invention. Unless otherwise specified, the components, software, firmware, hardware and/or instructions of the kit can be the same as those used in the invention.

The term approximately, as used herein, is defined as at least close to a given value (e.g., preferably within 10% of, more preferably within 1% of, and most preferably within 0.1% of). The term substantially, as used herein, is defined as at least approaching a given state (e.g., preferably within 10% of, more preferably within 1% of, and most preferably within 0.1% of). The term coupled, as used herein, is defined as connected, although not necessarily directly, and not necessarily mechanically. The term deploying, as used herein, is defined as designing, building, shipping, installing and/or operating. The term means, as used herein, is defined as hardware, firmware and/or software for achieving a result. The term program or phrase computer program, as used herein, is defined as a sequence of instructions designed for execution on a computer system. A program, or computer program, may include a subroutine, a function, a procedure, an object method, an object implementation, an executable application, an applet, a servlet, a source code, an object code, a shared library/dynamic load library and/or other sequence of instructions designed for execution on a computer system. The terms including and/or having, as used herein, are defined as comprising (i.e., open language). The terms a or an, as used herein, are defined as one or more than one. The term another, as used herein, is defined as at least a second or more.

### Practical Applications of the Invention

A practical application of the invention that has value within the technological arts is in developing applications and programs that primarily use the faster RAM, and only use the slower, shared RAM for information exchange between CPUs that do not have access tot he same portion of fast access RAM, at similar speeds of access. Further, the invention is useful in conjunction with a computer system where more than one CPU has access to the RAM subsystem, or portions thereof, some means of providing mutually exclusive access to the shared memory among the multiple CPUs. There are virtually innumerable uses for the invention, all of which need not be detailed here.

### Advantages of the Invention

A shared as needed programming model, representing an embodiment of the invention, can be cost effective and advantageous for at least the following reasons. The invention improves quality and/or reduces costs compared to previous approaches.

All the disclosed embodiments of the invention disclosed herein can be made and used without undue experimentation in light of the disclosure. Although the best mode of carrying out the invention contemplated by the inventor(s) is disclosed, practice of the invention is not limited thereto. Accordingly, it will be appreciated by those skilled in the art that the invention may be practiced otherwise than as specifically described herein.

Further, the individual components need not be formed in the disclosed shapes, or combined in the disclosed configurations, but could be provided in virtually any shapes, and/or combined in virtually any configuration. Further, the individual components need not be fabricated from the disclosed materials, but could be fabricated from virtually any suitable materials.

Further, variation may be made in the steps or in the sequence of steps composing methods described herein.

Further, although the shared as needed programming model described herein can be a separate module, it will be manifest that the shared as needed programming model may be integrated into the system with which it is associated. Furthermore, all the disclosed elements and features of each disclosed embodiment can be combined with, or substituted for, the disclosed elements and features of every other disclosed embodiment except where such elements or features are mutually exclusive.

It will be manifest that various substitutions, modifications, additions and/or rearrangements of the features of the invention may be made without deviating from the spirit and/or scope of the underlying inventive concept. It is deemed that the spirit and/or scope of the underlying inventive concept as defined by the appended claims and their equivalents cover all such substitutions, modifications, additions and/or rearrangements.

The appended claims are not to be interpreted as including means-plus-function limitations, unless such a limitation is explicitly recited in a given claim using the phrase(s) “means for” and/or “step for.” Subgeneric embodiments of the invention are delineated by the appended independent claims and their equivalents. Specific embodiments of the invention are differentiated by the appended dependent claims and their equivalents.

What is claimed is:

1. A method, comprising:
interconnecting a compute node with a shared memory node via hardware over a link medium; and
providing a shared memory operating system extension layer.

2. The method of claim 1, further comprising interconnecting another compute node with the shared memory node via hardware over the link medium.

3. The method of claim 1, wherein the shared memory operating system extension layer includes an application programming interface.

4. The method of claim 1, providing the shared memory operating system extension layer includes providing a function call.

5. The method of claim 1, providing the shared memory operating system extension layer includes providing another function call.

6. The method of claim 4, wherein the function call includes a shared memory management function call.

7. The method of claim 6, wherein the shared memory management function call manages pools of shared memory.

8. The method of claim 6, wherein the shared memory management function call includes a shared memory allocation function call.

9. The method of claim 8, wherein the shared memory allocation function call allows applications to reserve varying lengths of contiguous shared memory to hold data.

10. The method of claim 9, wherein the varying lengths of contiguous shared memory are shared and updated by a plurality of processors.

11. The method of claim 6, wherein the shared memory management function call includes a shared memory release function call.

12. The method of claim 11, wherein the shared memory release function call allows applications to release varying lengths of contiguous shared memory.

13. The method of claim 6, wherein the shared memory management function call includes a shared memory ownership function call.

14. The method of claim 13, wherein the shared memory ownership function call marks shared memory regions as exclusive to at least one of a plurality of processors.

15. The method of claim 6, wherein the shared memory management function call includes a shared memory ownership transfer function call.

16. The method of claim 15, wherein the shared memory ownership transfer function call transfers ownership of shared memory regions from a first set of processors to a second set of processors.

17. The method of claim 4, wherein the function call includes an interprocessor synchronization function call.

18. The method of claim 17, wherein the interprocessor synchronization function call includes a global lock reservation identifier function call.

19. The method of claim 18, wherein the global lock reservation identifier function call reserves at least one of a plurality of global synchronization primitives.

20. The method of claim 17, wherein the interprocessor synchronization function call includes a global lock release identifier function call.

21. The method of claim 20, wherein the global lock release identifier function call releases at least one of a plurality of global synchronization primitives.

22. The method of claim 17, wherein the interprocessor synchronization function call includes a global lock acquisition function call.

23. The method of claim 21, wherein the global lock acquisition function call locks one ore more global locks.

24. The method of claim 17, wherein the interprocessor synchronization function call includes a global lock release function call.

25. The method of claim 24, wherein the global lock release function call unlocks at least one of a plurality of global locks.

26. The method of claim 4, wherein the function call includes an interprocessor communication function call.

27. The method of claim 26, wherein the interprocessor communication function call includes a single processor signaling function call.

28. The method of claim 27, wherein the single processor signaling function call sends a signal one of a plurality of processors.

29. The method of claim 26, wherein the interprocessor communication function call includes an all processor signaling function call.

30. The method of claim 29, wherein the all processor signaling function call sends a signal at least two of a plurality of processors.

31. The method of claim 26, wherein the interprocessor communication function call includes a single processor message sending function call.

32. The method of claim 31, wherein the single processor message sending function call exchanges data among applications.

33. The method of claim 32, wherein the single processor message sending function call contains a shared memory reservation and signaling function call.

34. The method of claim 26, wherein the interprocessor communication function call includes an all processor message sending function call.

35. The method of claim 34, wherein the all processor message sending function call exchanges data among applications.

36. The method of claim 35, wherein the all processor message sending function call contains a shared memory reservation and signaling function call.

37. A computer program, comprising computer or machine readable program elements translatable for implementing the method of claim 1.

38. An apparatus for performing the method of claim 1.

39. A network, comprising the apparatus of claim 38.

40. An electronic media, comprising the computer program of claim 37.

41. An apparatus, comprising the electronic media of claim 40.

42. A kit, comprising the electronic media of claim 40.

43. The kit of claim 42, further comprising instructions.

44. An apparatus, comprising:
a compute node;
a link medium coupled to the compute node; and
a shared memory node coupled to the link medium, the shared memory mode including a shared memory operating system extension layer.
